(19) United States
(12) Patent Application Publication
(10) Pub. No.: US 2022/0164078 A1
(43) Pub. Date: May 26, 2022

(54) DYNAMIC AND SELECTIVE PRESENTATION OF INTERACTION ZONES BY A COMPUTER PROGRAM BASED ON USER INTERACTION WITH CONTENT FROM OTHER COMPUTER PROGRAMS

(71) Applicant: Microsoft Technology Licensing, LLC, Redmond, WA (US)

(72) Inventors: Amy A. DEVRIES, Seattle, WA (US); Biwei LIU, Beijing (CN)

(21) Appl. No.: 16/953,604

(22) Filed: Nov. 20, 2020

(51) Int. Cl. G06F 3/0486; G06F 3/0481

(52) U.S. Cl. CPC G06F 3/0486; G06F 2203/04803; G06F 3/0481

(57) ABSTRACT

Methods are performed by a first computer program that receives information associated with content that is presented within a display area of a second computer program and with which a user has interacted. Display areas of the first and second computer programs are presented concurrently. Executable actions of the first computer program are identified based on the received information associated with the content. Interaction zones, each corresponding to a respective executable action, are presented within the first computer program display area. In response to detecting that the content has been dragged from the second computer program display area and dropped into one of the interaction zones (or that the content is otherwise associated with an interaction zone based on user input), the executable action corresponding to the particular interaction zone is performed with respect to the content. The information associated with the content may comprise a copy of the content.

### BACKGROUND

Today's dual screen and foldable mobile solutions enable convenient multifunctionality in a handheld device. These devices may comprise portable, multi-posture devices with symmetric screens that function together to provide productivity in a flexible form factor. Users may work with multiple open applications as is routinely done in systems having larger screens or multiple monitors (e.g., a laptop or desktop computer connected to one or more remote monitors). In the larger viewing systems and in the dual screen portable devices, users may interact with multiple application windows among the available screens and seamlessly switch their focus between applications.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A method performed by a first computer program executing on a computing device, and systems that are configured to perform such a method, are described herein. The method comprises receiving information, which is associated with content presented within a display area of a second computer program executable on the computing device, and with which a user has interacted. The display area of the second computer program is presented concurrently with a display area of the first computer program. One or more executable actions of the first computer program may be identified based on the information associated with the content. One or more interaction zones are presented within the display area of the first computer program. Each of the one or more interaction zones corresponds to a respective one of the one or more executable actions. In response to detecting that the content has been dragged from the display area of the second computer program and dropped into a particular one of the one or more interaction zones (or in response to detecting a user interaction that associates the content presented within the display area of the second computer program with a particular one of the one or more interaction zones), the executable action corresponding to the particular interaction zone is performed with respect to the content. The information associated with the content may comprise a copy of the content.

Further features and advantages of embodiments, as well as the structure and operation of various embodiments, are described in detail below with reference to the accompanying drawings. It is noted that the methods and systems are not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 is a block diagram of a system for dynamic and selective presentation of interaction zones for launching executable actions, according to an example embodiment.

FIG. 2 illustrates a first example arrangement of display areas of computer programs on a display, according to an example embodiment.

FIG. 3 illustrates a second example arrangement of display areas of computer programs on a display, according to an example embodiment.

FIG. 4 illustrates example display areas that contain selectable content and that are presented by a first computer program and a second computer program, respectively, according to an example embodiment.

FIG. 5 illustrates the example display areas of FIG. 4, wherein content presented in the display area of a second computer program has been selected based on a user interaction received via a user input device, according to an example embodiment.

FIG. 6 illustrates the example display areas of FIG. 4 where user interaction with respect to the selected content indicates the first computer program, and in response to the user interaction, the first computer program selectively and dynamically presents interaction zones in a display, according to an example embodiment.

FIG. 7 illustrates the example display areas of FIG. 4 where user interaction with respect to another type of displayed content of the second computer program triggers generation of a different set of interaction zones than those shown in FIG. 6 by the first computer program, according to an example embodiment.

FIG. 8 illustrates the example display areas of FIG. 4 where user interaction with respect to yet another type of displayed content of the second computer program triggers generation of a different set of interaction zones than those shown in FIG. 6 or FIG. 7 by the first computer program, according to an example embodiment.

FIG. 9 illustrates the example display areas of FIG. 4 where user interaction with respect to content of the first computer program triggers generation of a set of interaction zones corresponding to actions executable by the second computer program, according to an example embodiment.

FIG. 10 is a flowchart of a method for dynamically and selectively presenting interaction zones for launching an executable action in a display area of a first computer program, according to an example embodiment.

FIG. 11 is a flowchart of a method for dynamically and selectively presenting interaction zones for launching an executable action in a display area of a first computer program, according to an example embodiment.

FIG. 12 is a flowchart of a method for dynamically and selectively presenting interaction zones for launching an executable action in a display area of a first computer program, according to an example embodiment.

FIG. 13 is a block diagram of an example processor-based computer system that may be used to implement various embodiments.

The features and advantages of the embodiments described herein will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The present specification and accompanying drawings disclose one or more embodiments that incorporate the features of the disclosed embodiments. The scope of the embodiments is not limited only to the aspects disclosed herein. The disclosed embodiments merely exemplify the intended scope, and modified versions of the disclosed embodiments are also encompassed. Embodiments are defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Embodiments

Mobile and stationary computing devices may be capable of concurrently executing multiple computer programs and concurrently presenting display areas (e.g., windows) associated therewith. These concurrently-presented display areas may be presented via a single display or via two or more displays (e.g., on displays of a dual-screen device, etc.). For example, a first application display area and a second application display area may be concurrently displayed via a single display, or the first application display area may be displayed via a first display of a dual-screen device and the second application display area may be concurrently displayed via a second display of the dual-screen device. Similarly, an operating system display area may be displayed concurrently with an application display area via a single display or via two or more displays.

Each computer program (e.g., operating system or application) may be configured to perform one or more actions on behalf of a user. For example, an email program (e.g., Microsoft® Outlook®) may be configured to perform various actions such as open a new message, add an attachment, reply to a message, forward a message, update a calendar, or update a contact list. In another example, a web browser may be configured to perform various actions such as conduct a search based on text, image, or audio objects, add an object to a “favorites” list, add an object to a “collection” or a “reading list,” send an object to a printer, or send an object to an email or messaging program. Social media applications may be configured to perform various actions such as posting, sharing, uploading, or pinning content (e.g., text, a photo, an image, video, music, an article, a webpage link, a comment, a tweet, etc.) to a board, a feed, a page, a list, a story, a follower, or a friend, for example.

Methods and systems are described herein for dynamically determining a set of executable actions of a first computer program based on content that has been selected by a user in a display area of a second computer program. The executable actions may be represented as interaction zones (or drop zones) that are presented in a display area of the first computer program. Execution of an action may be triggered when the user associates the selected content from the display area of the second application with an interaction zone in the display area of the first application. For example, a user may select content in a display area of the second computer program and drag the content toward the display area of the first computer program. The first computer program may determine which actions it can perform with respect to the selected content based on information about the selected content. The first computer program may then present one or more drop zones within its display area, where each drop zone represents an executable action that is appropriate for the selected content. When the user drops the content into one of the presented drop zones (or otherwise associates the content with one of the presented drop zones), the first computer program performs the executable action that corresponds to the receiving drop zone.

By dynamically presenting content-sensitive drop zones, the user interface may be improved by reducing navigation complexities and conserving precious screen real estate, which is especially important in mobile devices and laptops. For example, the presentation of content-sensitive drop zones alerts a user to actions that can be performed on the selected content that the user might not be aware of and the drop zones may be conveniently located and scaled to make it easier for the user to initiate an action. Making the drop zones relatively large may provide visually obvious choices that are easy to select, especially on a small screen. In embodiments where drop zones are presented in a new tab (e.g., in a web browser) or as a temporary overlay that vanishes after content is placed in a drop zone, the original webpage or underlying application window state may be preserved to avoid disrupting the user's work.

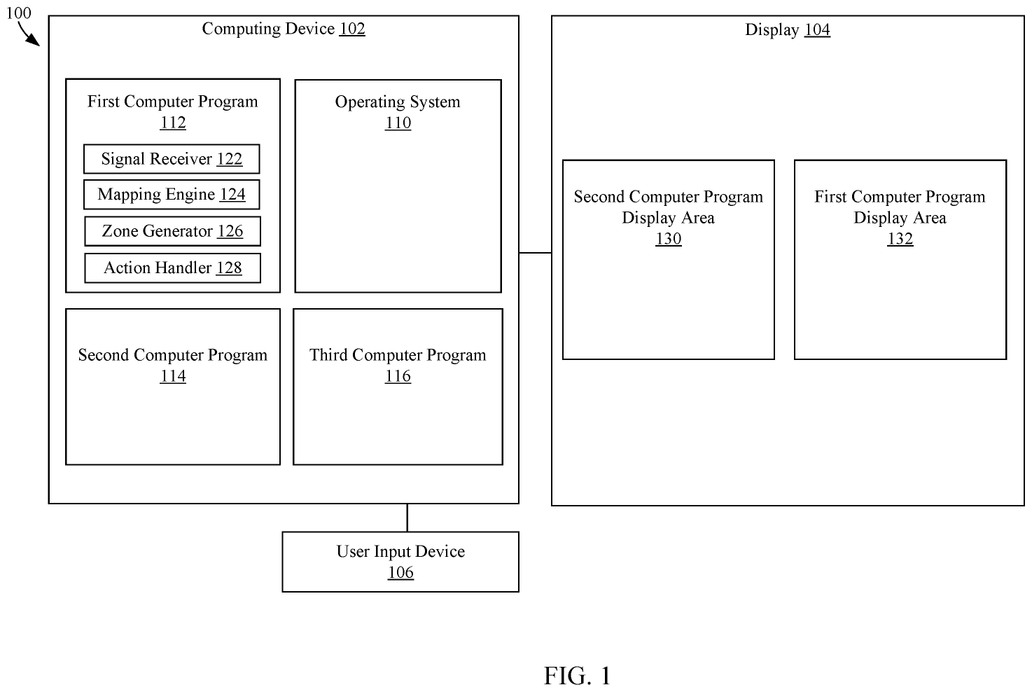

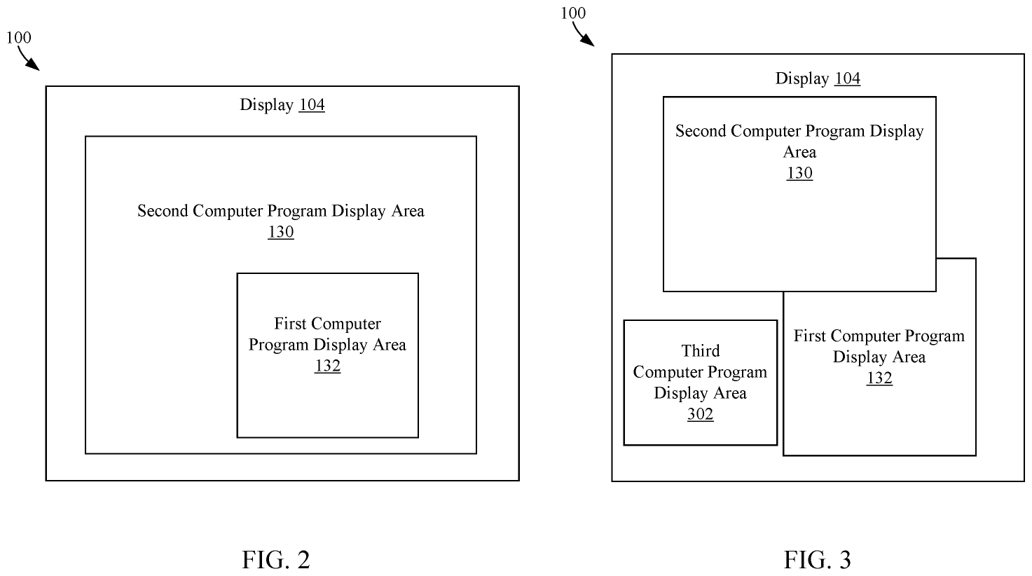

Embodiments for dynamic and selective presentation of interaction zones by a computer program, based on user interaction with content from another computer program, may be implemented in various ways. For example, FIG. 1 is a block diagram of a system 100 for dynamic and selective presentation of interaction zones for launching executable actions, according to an example embodiment. FIG. 2 illustrates a first example arrangement of display areas of computer programs on a display, according to an example embodiment. FIG. 3 illustrates a second example arrangement of display areas of computer programs on a display, according to an example embodiment.

As shown in FIGS. 1-3, system 100 includes a computing device 102, a display 104, and a user input device 106. Computing device 102 includes an operating system 110, a first computer program 112, a second computer program 114, and a third computer program 116. First computer program 112 includes a signal receiver 122, a mapping engine 124, a zone generator 126, and an action handler 128. Display 104 includes a first computer program display area 132 and a second computer program display area 130.

Computing device 102 may comprise any suitable computing device, such as a stationary computing device (e.g., a desktop computer or personal computer), a mobile computing device (e.g., a Microsoft® Surface® device, a personal digital assistant (PDA), a laptop computer, a dual screen device (e.g., a Microsoft® Surface Duo®), a notebook computer, a tablet computer such as an Apple iPad™, a netbook, etc.), a mobile phone (e.g., a cell phone, a smart phone such as an Apple iPhone, a phone implementing the Google® Android™ operating system, a dual screen phone; a Microsoft® Windows phone, etc.), a wearable computing device (e.g., a head-mounted device including smart glasses such as Google® Glass™, Oculus Rift® by Oculus VR, LLC, etc.), a gaming console/system (e.g., Nintendo Switch®, etc.), an appliance, a set top box, etc.

Display 104 may comprise one or more output devices for presenting information generated by computing device 102. Such output devices may comprise any suitable display technology such as liquid crystal (LCD), light-emitting diode (LED), organic light emitting-diode (OLED), plasma display panels (PDP), etc. Display 104 may comprise an integrated display screen of computing device 102, one or more separate screens or monitors, a projection from a projector, a headset (e.g., a virtual reality or augmented reality headset), or the like. In some embodiments, display 104 is integrated with user input device 106. For example, display 104 may comprise a touch screen (e.g., a user input device 106) for receiving user input for computing device 102. Display 104 may comprise one screen or multiple screens. For example, display 104 may comprise a laptop screen, a laptop screen and one or more monitors, two screens of a dual screen device (e.g., a smart phone or tablet dual screen device), or two or more monitors. As shown in FIGS. 1-3, the various display areas, such as second computer program display area 130, first computer program display area 132, and a third computer program display area 302 may be arranged in various ways over display 104 (e.g., among one or more display screens or monitors). For example, referring to FIG. 1, second computer program display area 130 may be presented side by side in display 104 with first computer program display area 132. Referring to FIG. 2, first computer program display area 132 is nested or enclosed within second computer program display area 130. Moreover, referring to FIG. 3, third computer program display area 302 is also presented in display 104, where the various display areas 130, 132, and 302 may be arranged side by side and/or in an overlapping fashion.

User input device 106 may comprise one or more user input devices configured to provide data and/or control signals to computing device 102 based on a user's gestures or manipulation of the input device's controls. In some embodiments user input device 106 is integrated within display 104 and/or within computing device 102. Examples of an input device 106 include a mouse, keyboard, track pad, touch screen, stylus, eye tracker, scanner, digital camera, joystick, and microphone. A user may interact with a computer program (e.g., operating system 110, first computer program 112, second computer program 114, third computer program 116, etc.) via user input device 106. For example, the computer program may receive user input such as a selection interaction, a hover interaction, a tap interaction, a click interaction, a click and hold interaction, a drag interaction, a drop interaction, a voice interaction, etc., via user input device 106. Moreover, the computer program may receive text input from a physical or virtual keyboard. In some embodiments, multiple user input devices 106 (e.g., a mouse and keyboard, etc.) may be utilized to convey a user's input to computing device 102.

Computing device 102 may be communicatively coupled to each of display 104 and user input device 106 via any suitable communication medium (e.g., wired, wireless, optical, etc.). In some embodiments, computing device 102 is configured to communicate with display 104 and/or user input device 106 via a network. In some embodiments, computing device 102 and one or both of display 104 and user input device 106 may be integrated into a single device (e.g., in a phone with a touch screen, a dual screen device with two touch screens, a laptop with a track pad and LCD display, etc.). In other embodiments, computing device 102 may be separate from one or both of display 104 and user input device 106 (e.g., a laptop or desktop computer communicatively coupled to one or more separate monitors, a mouse, a keyboard, a stylus, etc.).

Operating system 110 may be configured to, among other things, track a pointer (e.g., a mouse pointer, a cursor, touch screen contact pointer, etc.) that corresponds to user input received from input device 106 and pixel locations in display areas of display 104 (e.g., second computer program display area 130, first computer program display area 132, etc.). In various embodiments, the pointer comprises a target pixel that may be referred to as a “hot spot.” Operating system 110 may be configured to track the location of the “hot spot” as it changes position through one or more of the computer program display areas, and recognize its pixel position as the position of the pointer. One skilled in the art would understand that a user interaction via input device 106 in relation to locations of objects (e.g., graphic elements, text elements, etc.) having the “hot spot,” may raise events (e.g., select an object, drag and drop an object, hover an object, etc.). The events may be processed by operating system 110, first computer program 112, and/or second computer program 114. In one embodiment, operating system 110 may be configured to track pointer locations and/or user input received via user input device 106 and transmit the pointer locations and/or user input to first computer program 112, second computer program 114, and/or other computer programs. First computer program 112 may be configured to obtain a pointer location and events that are raised based on user input with a selected graphic element of first computer program display area 132, which is indicated by the pointer location, and perform an executable action that is associated with the selected graphic element.

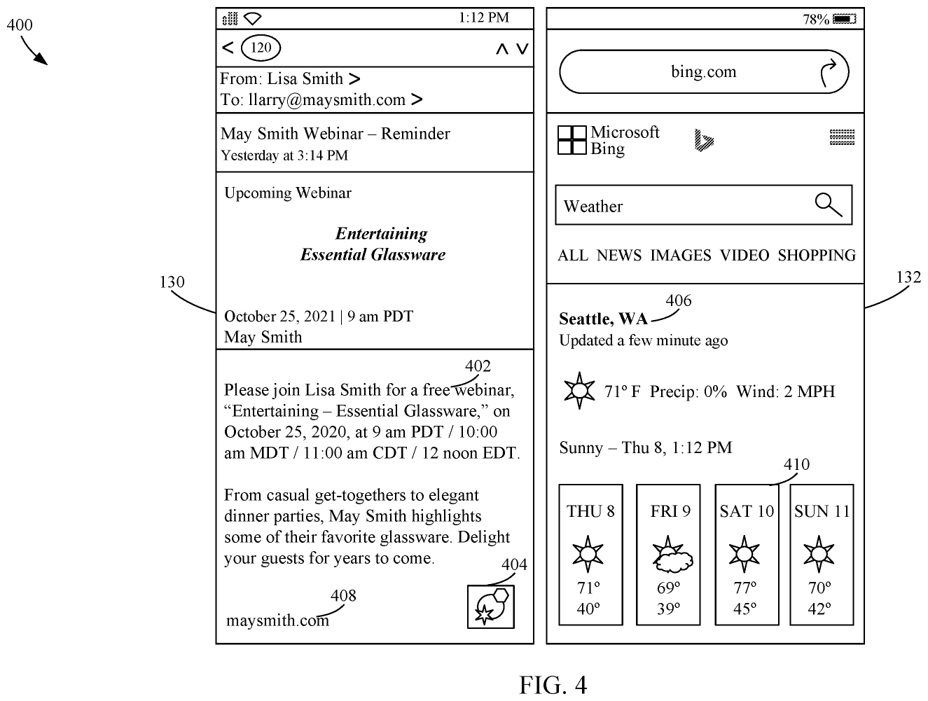

Embodiments for dynamic and selective presentation of interaction zones by a computer program, based on user interaction with content from another computer program, may be implemented in various ways. For example, FIG. 4 illustrates example display areas that contain selectable content and that are presented by a first computer program and a second computer program, respectively, according to an example embodiment.

As shown in FIG. 4, system 400 includes second computer program display area 130 and first computer program display area 132. Second computer program display area 130 is presented by second computer program 114. Second computer program display area 130 may include text content 402, image content 404, and uniform resource locator (URL) content 408. First computer program display area 132 is presented by first computer program 112. First computer program display area 132 may include location content 406 and temperature and date content 410.

In general, various types of computer programs, such as first computer program 112 and/or second computer program 114, may present content and/or interactive elements in a display (e.g., a graphical user interface (GUI)). For example, various computer programs that comprise user interfaces may include text editors (Microsoft® Word, PowerPoint®, etc.), web browsers (e.g., Microsoft® Edge, Google® Chrome, Safari, Vivaldi®, Netscape® Navigator, etc.), email programs (e.g., Microsoft® Outlook, Apple Mail, Mailbird®, etc.), search engines (e.g., Bing, Google®, Yahoo!®, etc.), social media apps (e.g., Pinterest®, SnapChat®, Instagram®; LinkedIn®, etc.), spreadsheet applications (EXCEL, Google® Sheets, etc.), drawing or graphics editors (Adobe Photoshop®, Gimp, PaintShop® Pro., etc.), and the like.

Selectable content presented in a display area may be referred to as an object, and may include, for example, text, images, videos, graphics, geographical locations, URL links, GUI controls, etc. The content (or objects) may be moved from one location in the display area of a computer program to a different location in the same display area or a display area of a different computer program by a user. The content may be moved through various operations or procedures such as copy and paste, cut and paste, or drag and drop. In copy and cut operations, selected content is copied and written to a buffer to save the content, and then the content may be read from the buffer to move it to a destination position within a display area. However, in a drag and drop type of operation, the content may be moved from a source location to a destination location in the display without the interim step of storing the content in a buffer and reading the content from the buffer.

Various user interactions may be configured for executing a drag and drop type of operation. In general, through user interaction with user input device 106, a user may select content at a source location in a display and then select a destination location in the display for a drag and drop type of operation. For example, text presented in a display area of a text editor program may be selected by highlighting the text with a click and hold of a mouse button. The content may be dragged from the source location to a destination location, and the destination location may be selected (or indicated) by releasing the mouse button when the cursor aligns with the desired destination location. In another example, an email message presented in a display area of an email program may be selected and dragged into a folder of the email program and dropped in the folder with the release of a mouse button. However, one skilled in the art would understand that user interaction methods or gestures used for performing a drag and drop type of operation is a design choice and any suitable user interaction method could be designed for performing a drag and drop type of operation. For example, when user input device 106 is a touch screen, a user may interact by touching the screen, in a display area where the content is originally presented, and holding the touch for a specified time to select the content. The user may then touch the screen in a second display area and hold the touch for a specified time to release the content in a destination display area. Other types of user interactions for executing a drag and drop type of operation (i.e., moving displayed content from one display location to another display location without executing an interim save to a buffer and read from a buffer) may comprise screen taps, voice commands, tracked eye movements, etc.

Referring to FIG. 4, in one example, second computer program 114 comprises an email program and first computer program 112 comprises a web browser. In this example, second computer program display area 130 is a display area presented by the email program. First computer program display area 132 is a display area presented by the web browser. Second computer program display area 130 and first computer program display area 132 are presented concurrently in display 104. As noted above, display 104 may comprise one or more display devices. In one example, second computer program display area 130 and first computer program display area 132 are concurrently displayed on a single screen. In another example, second computer program display area 130 is presented in a first screen of a dual screen device and second computer program display area 130 is concurrently presented in a second screen of the dual screen device. However, as described above, the disclosure is not limited in this regard.

Second computer program display area 130 may include content, for example, text content 402, image content 404, and URL content 408. The content may have various characteristics and may be associated with various types of information. Other types of content shown in the display of the email program includes an email address (e.g., llarry@maysmith.com), a date, a time of day, the name of a company (e.g., May Smith), an activity (e.g., webinar). The example display of a web browser shown in first computer program display area 132 may include a webpage comprising location content 406 and temperature and date content 410, which may comprise text and/or a graphic. Other types of content shown in first computer program display area 132 may include text, graphics, a weather report, and a date and time report. In general, computer programs (e.g., applications or operating systems) may process received content in various ways depending on the type of content received and the functions or actions that a program is configured to perform. For example, a graphing program may receive temperature and date content 410, and may chart the temperature to a graph of daily temperature readings based on the date content. However, a text editor may receive the same temperature and date content 410 and insert it as text into a paragraph of a document. In another example, actions performed by a mapping program may include presenting a geographical map and a location marker in response to receiving geographical location content 406. In contrast, a search engine displayed in the webpage of the example web browser may receive the same geographical location content 406 and present a number of websites that have subject matter associated with the geographical location. In another example, image content 404 may comprise a photograph and may be received by a photo viewing computer program. In response, the image content 404 may be presented in display 104 for viewing the photo. The same image content 404 may be received by a search engine computer program, and in response, images having similar subject matter as that of image content 404 may be retrieved via the Internet and presented in a display area of the search engine. Moreover, the same image content 404 may be received by an image repository computer program and in response, the image of image content 404 may be stored in a database of images.

Moreover, a computer program may be capable of taking a plurality of different types of actions in response to receiving a single content item. In this regard, a computer program may have multiple features or sub-programs that are configured to perform different actions in response to receiving the same content. For example, the web browser presented in first computer program display area 132 (e.g., by first computer program 112) may have a favorites listing and access feature for listing webpages that a user has selected or identified as a favorite. The web browser may also have a collections feature where users may select or identify content such as images, URLs, text, video, etc., and the collections feature will organize and present the collected content to the user when a particular collection is opened. The web browser may also provide a search feature by presenting a search engine in first computer program display area 132 that enables a user to perform one or more types of searches (e.g., image search, text search, audio search) depending on the type of content received. Also, a print feature of first computer program 112 may be configured to initiate printing of several types of content such as text, images, URLs, graphics, etc. A share feature of the web browser may be configured to open a messaging program in response to receiving content and enabling sending of the selected content via a message to another device. Similarly, the email program presented in second computer program display area 130 may comprise email messaging features, calendar and appointment features, and contact listing features. The email program may take various actions such as replying to an email message, forwarding a message, opening a new message, and adding an event to a calendar.

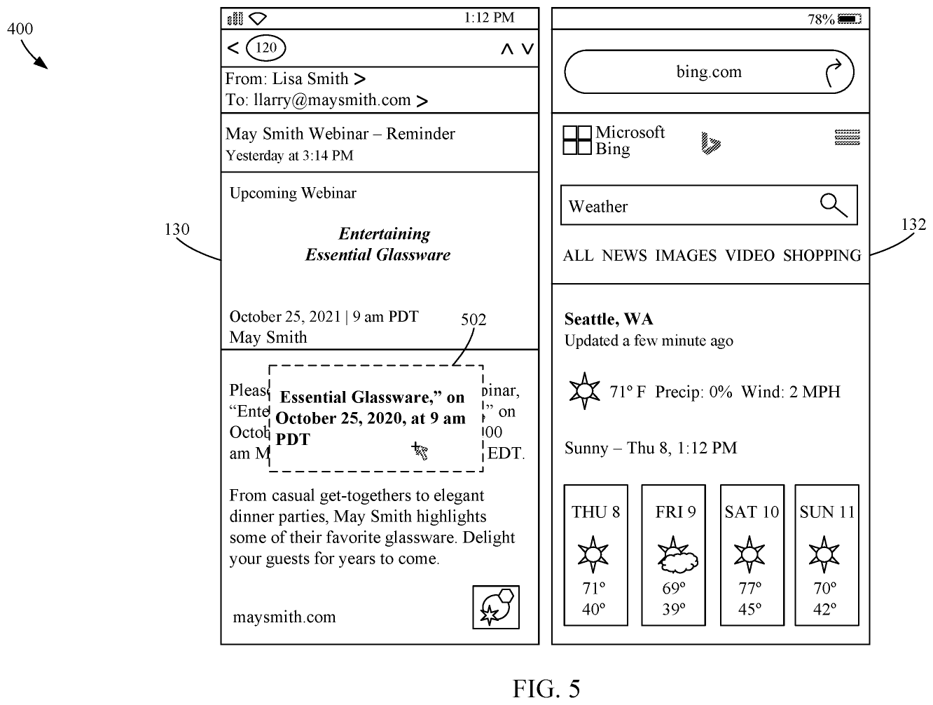

Embodiments for dynamic and selective presentation of interaction zones by a computer program, based on user interaction with content from another computer program, may be implemented in various ways. For example, FIG. 5 illustrates the example display areas of FIG. 4, wherein content presented in the display area of a second computer program has been selected based on a user interaction received via a user input device, according to an example embodiment.

As shown in FIG. 5, system 400 includes second computer program display area 130, first computer program display area 132, and selected content 502.

Selected content 502 may comprise content that is displayed in second computer program display area 130 and that has been selected by a user via user input device 106. Selected content 502 may be referred to as content with which a user has interacted. In one example, selected 502 may include text comprising various types of information, such as a date, a time, and an item (e.g., “Essential Glassware”) that may represent a webinar name, a type of product that may be pursued in a shopping project or a museum show, or may be crafted in an artisan studio, etc. Various information may be associated with selected content 502, such as information about what the content represents (e.g., text, an item, a date, a time, etc.), a content type, a file type (.wav, .png, .jpg, .gif, etc.), a data type, formatting information, a category associated with the content, a source of the content (e.g., second computer program 114), the destination of the content (e.g., first computer program 112), and the like. Alternatively or in addition, the information associated with selected content 502 may comprise a copy of the content. In one example, a user may select selected content 502 by initiating a drag and drop type of operation using user input device 106 (e.g., by clicking and holding a mouse button, or touching, and holding the touch, in a touch screen device of display 104). However, the disclosure is not limited with respect to any specific type of user input device 106, or any specific manipulation of the input device 106 that conveys a user interaction to a computer program, and any suitable input device or user manipulation of the device may be utilized.

One or more of first computer program 112, second computer program 114, and operating system 110 may detect a user interaction with selected content 502, and may determine that a drag and drop type of user interaction has been initiated with selected content 502.

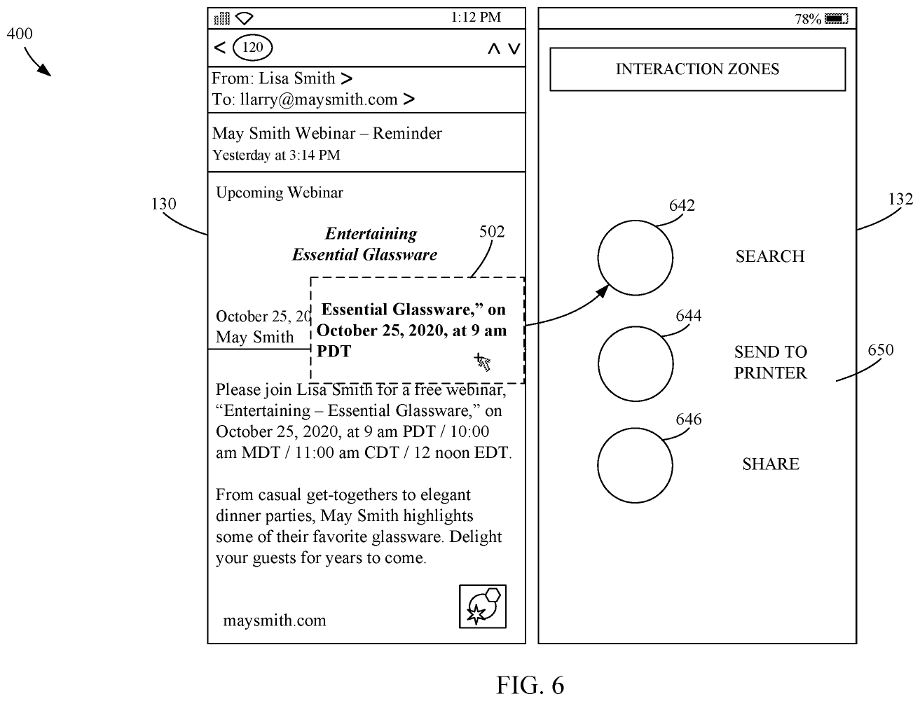

Embodiments for dynamic and selective presentation of interaction zones by a computer program based on user interaction with content from another computer program, may be implemented in various ways. For example, FIG. 6 illustrates the example display areas of FIG. 4 where user interaction with respect to the selected content indicates the first computer program, and in response to the user interaction, the first computer program selectively and dynamically presents interaction zones in a display, according to an example embodiment.

As shown in FIG. 6, system 400 includes second computer program display area 130, first computer program display area 132, selected content 502, a search interaction zone 642, a send to printer interaction zone 644, a share interaction zone 646, and a new tab or overlay 650.

As described above, second computer program display area 130 and first computer program display area 132 may be presented concurrently in display 104. One or more of first computer program 112, second computer program 114, and operating system 110 may be configured to detect a user interaction with selected content 502, and determine that a drag and drop type of user interaction has been initiated. In response to the user interaction, one or more of first computer program 112, second computer program 114, and operating system 110, may be configured to determine which display area is the destination display area for the drag and drop type of interaction. For example, it may be determined that first computer program display area 132 is the destination display area based on (1) an initiation of dragging of selected content 502 within second computer program display area 130, (2) a spatial direction of dragging of selected content 502 towards first computer program display area 132, (3) dragging of selected content 502 across a boundary of first computer program display area 132, (4) dragging of selected content 502 across a boundary of second computer program display area 130, (5) dragging of selected content 502 within a specified distance of first computer program display area 132, (6) selection of selected content 502 within second computer program display area 130, or (7) hovering selected content 502 over first computer program display area 132.

In response to determining that first computer program display area 132 is the destination display area for the drag and drop type of operation, signal receiver 122 of first computer program 112 may be configured to receive the information associated with selected content 502 and may identify one or more executable actions of first computer program 112 that may be performed with respect to selected content 502 based on the information associated with selected content 502. For example, first computer program 112 may include a text search engine and an image search engine. Mapping engine 124 may be configured to determine that selected content 502 comprises text and that first computer program 112 can execute a text search based on the text, and would not perform an image search based on the text. First computer program 112 may also be configured to perform an action such as execute delivery of content to a printing function or to a message sending function. Mapping engine 124 may be configured to determine that selected content 502 may be printed by a printer or may be included in a text message that is sent to another device.

Zone generator 126 of first computer program 112 may be configured to generate a new tab or overlay 650 comprising interaction zones that are determined based on the information associated with selected content 502. For example, zone generator 126 may be configured to open a new tab in the web browser of first computer program display area 132 and present interaction zones in a display area of the new tab. In some embodiments, zone generator 126 may present a display overlay that may overlay first computer program display area 132 and may comprise the interactions zones. The new tab or the overlay may be temporary and may disappear or cease to be displayed when an interaction zone is interacted with by the user or the user releases selected content 502 without interacting with an interaction zone. Alternatively, or in addition to new tabs and/or overlays, zone generator 126 may present interaction zones based on any other suitable user interface design (e.g., graying content of first computer program display area 132 and presenting the interaction zones over the grayed content). Example interaction zones may include one or more interactions zones such as: (1) search interaction zone 642 that corresponds to executing a text search based on selected content 502, (2) send to printer interaction zone 644 that corresponds to sending selected content 502 to a printer for printing, and (3) share interaction zone 646 that corresponds to sending selected content 502 to text messaging software. In some embodiments, where only one action is available to be performed by first computer program 112, the new tab or overlay 650 itself may comprise a single interaction zone.

A user may indicate that one of the presented interaction zones is a destination interaction zone for associating an executable action with selected content 502 via user input device 106. For example, a user may indicate an association between selected content 502 and one of the user interaction zones 642, 644, or 646 by dropping or releasing content into a representation of an interaction zone in display area 132. In response to detecting the user interaction that associates selected content 502 with a particular one of the one or more interaction zones 642, 644, or 646, action handler 128 may be configured to perform the executable action corresponding to the particular interaction zone with respect to selected content 502 (e.g., executing a search based on selected content 502, sending selected content 502 to a printer for printing, or sending selected content 502 to a text messaging program to be added to a text message).

In some embodiments, in response to detecting that selected content 502 has been dragged from second computer program display area 130 and dropped into a particular one of the one or more interaction zones (e.g., search interaction zone 642, send to printer interaction zone 644, or share interaction zone 646), action handler 128 may be configured to perform the executable action corresponding to the particular interaction zone with respect to selected content 502. For example, in instances where a user drags selected content 502, comprising text including the word “glassware,” to search interaction zone 642, first computer program 112 may be configured to respond by performing a subject matter search based on the word glassware and present a list of shopping websites that may be accessed by the user for shopping for glassware. New tab or overlay 650 may disappear or cease to be displayed after the user associates selected content 502 with an interaction zone. In some embodiments, the webpage comprising location content 406 and temperature and date content 410 of first computer program display area 132 (shown in FIG. 4) may remain open after new tab or overlay 650 is opened and/or closed.

In general, there may be many ways to select and enter content into a user interface and initiating an action of a computer program based on the content. Often, user interfaces are so complex that users must hunt through many screens and drop-down boxes, etc., to find the interface element they looking for. Even for a simple drag and drop operation, a user must find a specific place or window in a user interface to drop the content. The surfacing of content sensitive interactions zones in a display area of a new tab or a display overlay provides users with a more efficient and streamlined way of passing content to an application and initiating an action. For example, by presenting only the interaction zones that represent actions available for the selected content, the method reduces the cognitive load associated with finding a specific element in a user interface or discovering which features are available in a computer program. Moreover, by presenting content sensitive interaction zones in a new tab or overlay, as described herein, user interface designers may make a more efficient use of screen real estate. For example, designers may reduce the number of interactive elements that are presented in a user interface display area, or that are hidden from view and requiring additional navigation steps to access. These efficiencies are even more important in small screen devices where the amount of space available for UI elements is very limited. In addition, by opening a new tab and/or a display overlay with interactions zones for receiving content and performing an action (e.g., conducting a search and opening a new webpage based on the content), the computer program display area that was originally open may remain open after the interactions zones are utilized (e.g., after the search results are presented).

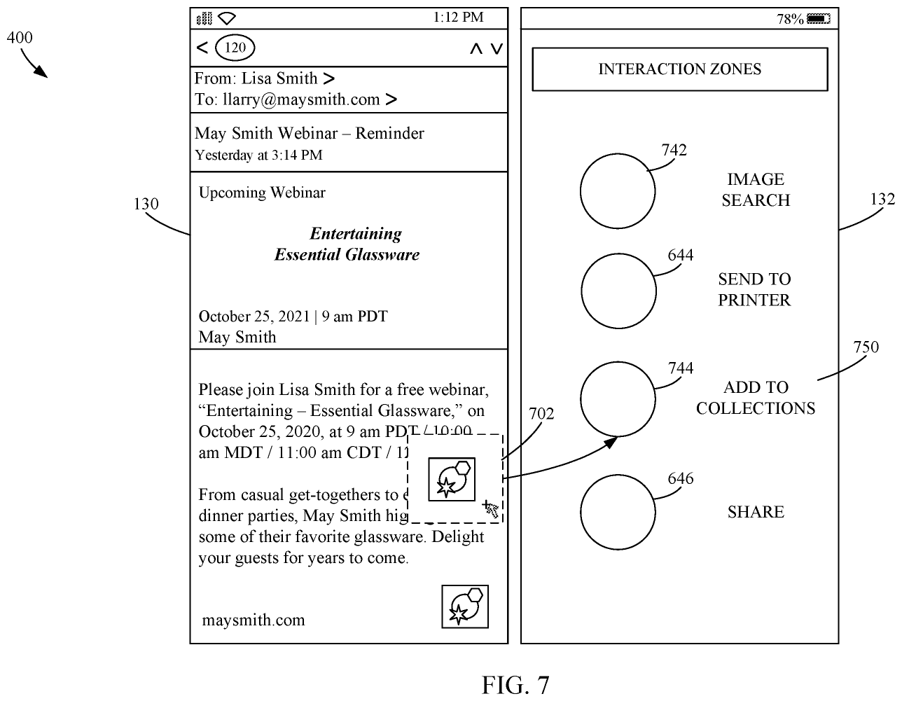

Embodiments for dynamic and selective presentation of interaction zones by a computer program based on user interaction with content from another computer program, may be implemented in various ways. For example, FIG. 7 illustrates the example display areas of FIG. 4 where user interaction with respect to another type of displayed content of the second computer program triggers generation of a different set of interaction zones than those shown in FIG. 6 by the first computer program, according to an example embodiment.

As shown in FIG. 7, system 400 includes second computer program display area 130, first computer program display area 132, selected content 702, an image search interaction zone 742, send to printer interaction zone 644, an add to collections interaction zone 744, share interaction zone 646, and a new tab or overlay 750.

In one embodiment, selected content 702 may comprise an image, such as a photograph, with which a user has interacted. One or more of first computer program 112, second computer program 114, and operating system 110 may be configured to detect a user interaction with selected content 702, and determine that a drag and drop type of operation has been initiated. In response to the user interaction, one or more of first computer program 112, second computer program 114, and operating system 110, may be configured to determine which display area is the destination display area for the drag and drop type of operation.

In response to determining that first computer program display area 132 is the destination display area for the drag and drop type of operation, signal receiver 122 of first computer program 112 may be configured to receive the information associated with selected content 702. The associated information may indicate that the content comprises an image, a file type of the selected content, a data type of the selected content, formatting information of the selected content, a source of the selected content (e.g., the second computer program 114), a destination of the selected content (the first computer program 112), and the like. In some embodiments, the information associated with selected content 702 may comprise the image itself. In response to receiving the information associated with selected content 702, mapping engine 124 may be configured to determine executable actions that first computer program 112 may perform with respect to an image. For example, mapping engine 124 may determine that the actions appropriate for the image of selected content 702 include executing an image search, sending an image to a printer for printing, adding an image to a collection, or sending an image to a text messaging program to be added as an attachment to a text message. On the other hand, mapping engine 124 may determine that a text search or adding the image to a favorites list would not be appropriate actions for the image content.

Zone generator 126 of first computer program 112 may be configured to dynamically generate a new tab or overlay 750 comprising user interaction zones for the executable actions that are appropriate for the image of selected content 702. For example, zone generator 126 may be configured to open a new tab in the web browser of first computer program display area 132 and present the interaction zones in a display area of the new tab. Alternatively, zone generator 126 may be configured to open a display overlay over the first computer program display area 132 and present the interactions zones in the overlay. The interactions zones may represent actions including, for example: (1) image search interaction zone 742 that corresponds to executing an image search based on selected content 702, (2) send to printer interaction zone 644 that corresponds to sending the image of selected content 702 to a printer for printing, (3) add to collections interaction zone 744 to execute adding an image file comprising the image of selected content 702 to a collection that is configured by the user in the first computer program 112, and (4) share interaction zone 646 that corresponds to sending selected content 702 to messaging software to be added as an attachment in a text message, which may be sent via a network.

A user may indicate an association between selected content 702 and one of the interaction zones 742, 644, 744, or 646. For example, in response to detecting that the user interaction associates selected content 702 with add to collections interaction zone 744, action handler 128 may be configured to execute a save of the image file of selected content 702 in a collection configured by the user in first computer program 112. New tab or overlay 750 may disappear or cease to be displayed after the user associates selected content 702 with an interaction zone, and the webpage comprising location content 406 and temperature and date content 410 of first computer program display area 132 (shown in FIG. 4) may remain open.

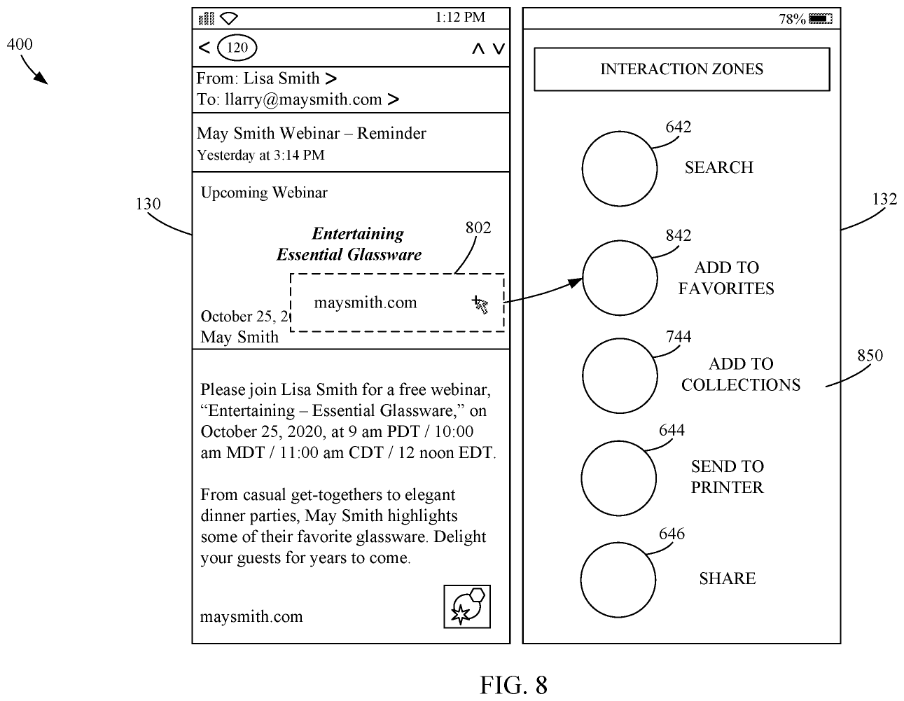

Embodiments for dynamic and selective presentation of interaction zones by a computer program based on user interaction with content from another computer program, may be implemented in various ways. For example, FIG. 8 illustrates the example display areas of FIG. 4 where user interaction with respect to yet another type of displayed content of the second computer program triggers generation of a different set of interaction zones than those shown in FIG. 6 or FIG. 7 by the first computer program, according to an example embodiment.

As shown in FIG. 8, system 400 includes second computer program display area 130, first computer program display area 132, selected content 802, search interaction zone 642, an add to favorites interaction zone 842, add to collections interaction zone 744, send to printer interaction zone 644, share interaction zone 646, and a new tab or overlay 850.

In one embodiment, selected content 802 may comprise a link to a website, such as a URL, with which a user has interacted. One or more of first computer program 112, second computer program 114, and operating system 110 may be configured to detect a user interaction with selected content 802, and determine that a drag and drop type of operation has been initiated. In response to the user interaction, one or more of first computer program 112, second computer program 114, and operating system 110, may be configured to determine which display area is the destination display area for the drag and drop type of operation.

In response to determining that first computer program display area 132 is the destination for the drag and drop type of operation, signal receiver 122 of first computer program 112 may be configured to receive information associated with selected content 802, which may indicate that the selected content comprises a URL or may indicate other information about the selected content. In response to receiving the information associated with selected content 802, mapping engine 124 may be configured to determine one or more executable actions that first computer program 112 is operable to perform with respect to a URL. For example, first computer program 112 may comprise a web browser displaying a web page for a search engine that may be operable to execute an Internet search based on the URL. In another example, first computer program 112 may have an add to favorites feature that is configured to take an action such as constructing a list of favorite websites and/or webpages and adding a URL to the favorites list. First computer program 112 may also have a printing feature that may be configured to take an action such as sending a URL to a printer for a printing action such as printing the URL. First computer program 112 may also be configured to send a URL to a message program to be added as a link in a text message.

Zone generator 126 of first computer program 112 may be configured to dynamically generate a new tab or overlay 850 comprising user interaction zones for executable actions that are appropriate for the URL of selected content 802. For example, zone generator 126 may be configured to open a new tab in the web browser of first computer program display area 132 and present interaction zones in a display area of the new tab. Alternatively, zone generator 126 may present an overlay in first computer program display area 132 and present the interaction zones in the overlay. Example actions represented by the interactions zones may comprise (1) search interaction zone 642 that corresponds to executing a search based on the URL of selected content 802, (2) add to favorites interaction zone 842 that corresponds to executing the adding of the URL to a favorites list of the user, (3) add to collections interaction zone 744 that corresponds to executing the adding of the URL to a collection of the user, (4) send to printer interaction zone 644 that corresponds to sending of the URL of selected content 802 to a printer for printing, and (5) share interaction zone 646 that corresponds to sending of the URL of selected content 802 to text messaging software to add the URL to a text message to be sent via a network to another device.

A user may indicate an association between selected content 802 and one of the user interaction zones 642, 842, 744, 644, or 646. For example, in response to detecting that the user interaction associated selected content 802 with the add to favorites interaction zone 842, action handler 128 may be configured to execute a listing of the URL of selected content 802 in a favorites list that is configured in first computer program 112.

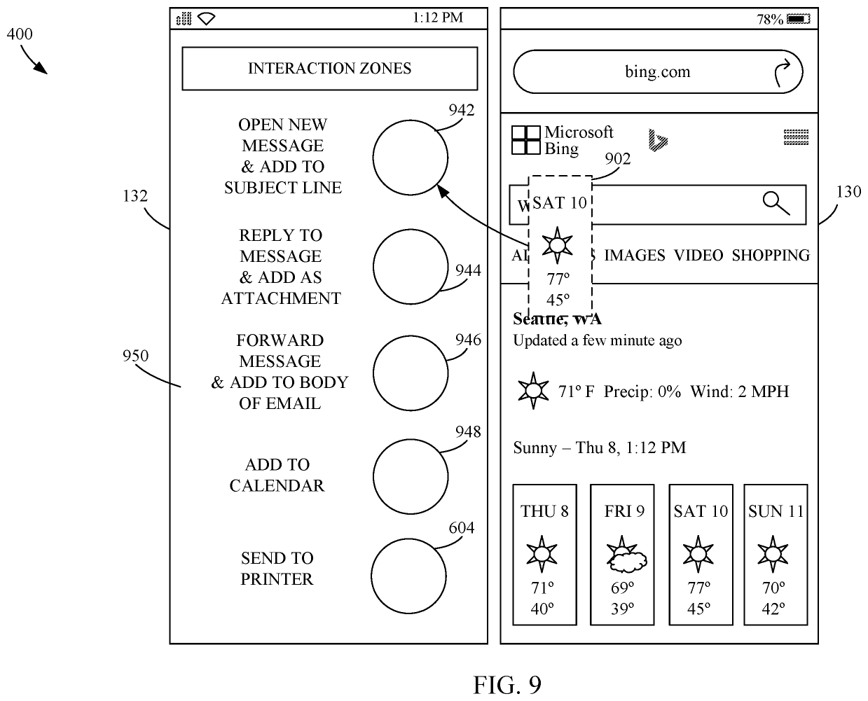

Embodiments for dynamic and selective presentation of interaction zones by a computer program based on user interaction with content from another computer program, may be implemented in various ways. For example, FIG. 9 illustrates the example display areas of FIG. 4 where user interaction with respect to content of the first computer program triggers generation of a set of interaction zones corresponding to actions executable by the second computer program, according to an example embodiment.

As shown in FIG. 9, system 400 includes second computer program display area 130, first computer program display area 132, selected content 902, an open new message and add to subject line interaction zone 942, a reply to message and add as attachment interaction zone 944, a forward message and add to body of email interaction zone 946, an add to calendar interaction zone 948, a send to printer interaction zone 644, and an overlay 950.

Referring to FIG. 9, a search engine search result is presented by a web browser in second computer program display area 130, and an email program user interface is presented in first computer program display area 132. As shown in FIG. 9, rather than a user selecting an object or content from the email program display area and moving it to the web browser display area for the web browser to perform an action with respect to the content, the user may move selected content from the web browser display area to the email program display area for executing an action by the email program.

In one embodiment, selected content 902 includes content with which a user has interacted from second computer program display area 130. Selected content 902 may comprise text and a graphic that indicates a weather forecast for a specified day, which was presented in display area 130 as a result of a search based on the word weather. One or more of first computer program 112, second computer program 114, and operating system 110 may be configured to detect a user interaction with selected content 902, and determine that a drag and drop type of operation has been initiated. In response to the user interaction, one or more of first computer program 112, second computer program 114, and operating system 110, may be configured to determine which display area is indicated as the destination display area based on characteristics of the drag and drop type of operation.

In response to determining that first computer program display area 132 is the destination for the drag and drop type of operation, signal receiver 122 of first computer program 112 may be configured to receive information associated with selected content 902. The information associated with selected content 902 may indicate that the selected content comprises text and a graphic describing a weather forecast for a specified day. In response to receiving the information associated with the selected content, mapping engine 124 may be configured to determine executable actions that first computer program 112 may be operable to perform with respect to the text and/or graphic describing the weather forecast for a specified day. For example, mapping engine 124 may be configured to determine that first computer program 112 comprises an email program configured to execute actions comprising: 1) opening of a new message and adding the text of selected content 902 to a subject line of the new email message, 2) replying to a message that may be open in first computer program display area 132, and adding the graphic of selected content 902 as attachment to the email reply, 3) forward an open email message and add the text and or graphic of selected content 902 to a body of the email message, 4) add the weather forecast of selected content 902 to calendar based on the date expressed in selected content 902, or 5) send the text and/or graphic of selected content 902 to printer for printing.

Zone generator 126 of first computer program 112 may dynamically generate an overlay 950 comprising user interaction zones for the executable actions that the email program may be operable to perform based on selected content 902. Overlay 950 may be presented in display 104 without closing the user interface of the email program, such that the user interface of the email program may remain open after user interaction with overlay 950 has triggered an executable action by first computer program 112. For example, zone generator 126 may be configured to open overlay 950 in first computer program display area 132 and present in overlay 950: (1) open new message and add to subject line interaction zone 942, which corresponds to executing opening of a new message and adding the text of selected content 902 to a subject line of the new email message, (2) reply to message and add as attachment interaction zone 944, which corresponds to executing a reply to a message that may be open by opening a new email message and adding the graphic of the selected content 902 as attachment to the new email message, (3) forward message and add to body of email interaction zone 946, which corresponds to executing forwarding of an already open message, by opening a new message that includes content of the already open message, and adding the text and/or graphic of selected content 902 to a body of the new email message, (4) add to calendar interaction zone 948, which corresponds to executing adding of the weather forecast of selected content 901 to a calendar utilizing the date expressed in selected content 902, and (5) send to printer interaction zone 644, which corresponds to executing the sending of the text and/or graphic of selected content 902 to printer for printing.

A user may indicate an association between selected content 902 and one of the user interaction zones 942, 944 946, 948, and 604. For example, in response to detecting that selected content 902 has been associated with the open new message and add to subject line interaction zone 942, action handler 128 may be configured to execute opening of a new email message and adding the text of selected content 902 to a subject line of the new email message.

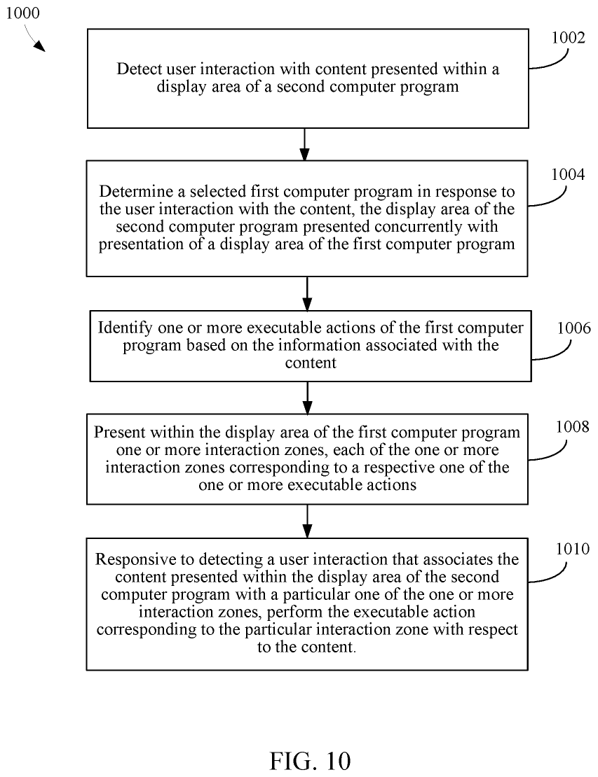

In embodiments, systems 100 and 400 may operate in various ways to perform their functions. For example, FIG. 10 is a flowchart of a method for dynamically and selectively presenting interaction zones for launching an executable action in a display area of a first computer program, according to an example embodiment.

Flowchart 1000 may be performed by computing device 102, display 104, and/or user input device 106. For the purpose of illustration, flowchart 1000 of FIG. 10 is described with reference to FIGS. 1-6. Flowchart 1000 of FIG. 10 begins with step 1002. In step 1002, a user interaction with content that is presented within a display area of a second computer program is detected. For example, one or more of first computer program 112, second computer program 114, and operating system 110 may detect user interaction with selected content 502 via user input device 106, and may determine that a drag and drop type of operation has been initiated. Selected content 502 may comprise content presented in second computer program display area 130.

In step 1004, in response to the user interaction with the content it is determined that a first computer program has been selected where the display area of the second computer program is presented concurrently with presentation of a display area of the first computer program. For example, in response to detecting the user interaction with selected content 502, one or more of first computer program 112, second computer program 114, and operating system 110, may determine that first computer program display area 132, which is open concurrently with second computer program display area 130, is the destination display area for the drag and drop type of operation.

In step 1006, one or more executable actions of the first computer program are identified based on the information associated with the content. For example, in response to determining that first computer program display area 132 is the destination computer program for the drag and drop type of operation, signal receiver 122 of first computer program 112 may receive information associated with selected content 502. For example, operating system 110 may send information associated with selected content 502 to first computer program 112. The associated information may indicate that the selected content comprises text or other properties of selected content 502. In response to receiving the information associated with selected content 502, mapping engine 124 may be configured to determine which executable action(s) first computer program 112 is operable to perform with respect to the text of the drag and drop type of operation. For example, first computer program 112 may comprise a web browser and may be operable to initiate a search via a search engine based on text of selected content 502, send the text to a printer for printing of the text, or send the text to a text messaging application to be included in a text message opened by the text messaging software.

In step 1008, one or more interaction zones may be presented within the display area of the first computer program where each of the one or more interaction zones corresponds to a respective one of the one or more executable actions. For example, zone generator 126 of first computer program 112 may dynamically generate a new tab or overlay 650 comprising user interaction zones for the executable actions the web browser is operable to perform based the information associated with selected content 502. In some embodiments, the associated information is a copy of the selected content 502 (e.g., the content itself). Zone generator 126 may open a new tab of the web browser or may present a temporary overly such that the webpage presented by the web browser may remain open after the new tab or overlay 650 is utilized and/or closed. Zone generator 126 may open new tab or overlay 650 in first computer program display area 132 and present interactions zones, which correspond to actions, comprising: 1) search interaction zone 642, which corresponds to initiating a text search, 2) send to printer interaction zone 644, which corresponds to sending the text to a printer for printing the text, and 3) share interaction zone 646, which corresponds to sending the text to a text messaging application for opening a text message and adding the text to the message.

In step 1010, in response to detecting a user interaction that associates the content presented within the display area of the second computer program with a particular one of the one or more interaction zones, the executable action that corresponds to the particular interaction zone is performed with respect to the content. For example, computer program 112 may receive, via the user input device 106, a user's indication that associates selected content 502 from second computer program display area 130 with one of the user interaction zones 642, 644, or 646 presented in the new tab or overlay 650. In response to detecting that the user interaction associates selected content 502 with search interaction zone 642, action handler 128 may execute sending of the text of selected content 502 to a text search engine represented in the first display area 132 of the web browser of first computer program 112, and the search engine may execute a text search based on the text of selected content 502.

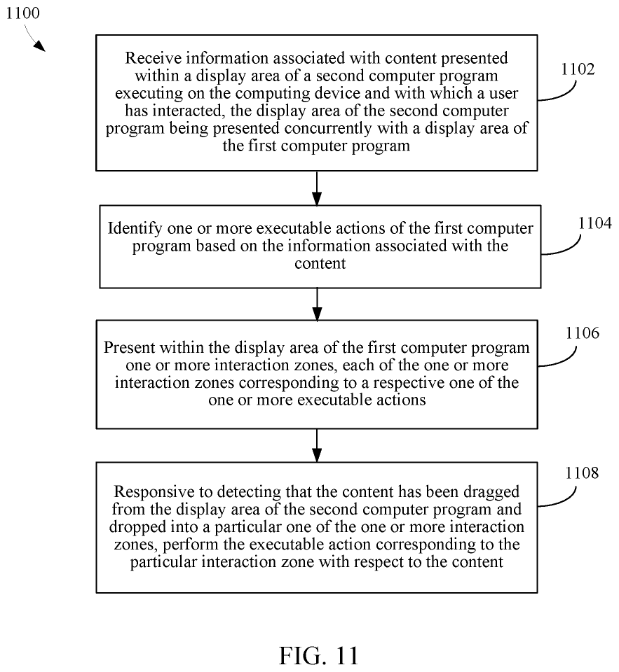

In embodiments, systems 100 and 400 may operate in various ways to perform their functions. For example, FIG. 11 is a flowchart of a method for dynamically and selectively presenting interaction zones for launching an executable action in a display area of a first computer program, according to an example embodiment.

Flowchart 1100 may be performed by computing device 102, display 104, and/or user input device 106. For the purpose of illustration, flowchart 1100 of FIG. 11 is described with reference to FIGS. 1-3 and 7. Flowchart 1100 of FIG. 11 begins with step 1102. In step 1102, information is received, where the information is associated with content that is presented within a display area of a second computer program that executes on the computing device and with which a user has interacted, where the display area of the second computer program is presented concurrently with a display area of the first computer program. For example, in one embodiment, selected content 702 may comprise an image, such as a photograph. One or more of first computer program 112, second computer program 114, and operating system 110 may detect the user interaction and determine that a drag and drop type of operation has been initiated. In response, one or more of first computer program 112, second computer program 114, and operating system 110, may determine that first computer program display area 132 is the destination program of the drag and drop type of operation. Signal receiver 122 of first computer program 112 may receive the information associated with selected content 702, which may indicate that the content comprises an image and/or other various properties of selected content 702 such as file type, data type, formatting, etc. Moreover, the information associated with selected content 702 may comprise a copy of the image of selected content 702.

In step 1104, one or more executable actions of the first computer program may be identified based on the information associated with the content. For example, mapping engine 124 may determine executable actions that first computer program 112 may perform with respect to an image. In some embodiments, first computer program 112 may comprise a web browser that may initiate a search in an image search engine, execute sending an image to a printer for printing, execute adding an image to a collection, or execute sending an image to a text message program to be added as an attachment to a text message.

In step 1106, one or more interaction zones may be presented within the display area of the first computer program where each of the one or more interaction zones corresponds to a respective one of the one or more executable actions. For example, zone generator 126 of first computer program 112 may dynamically generate a new tab or overlay 750 comprising user interaction zones representing the executable actions appropriate for the image of selected content 702. For example, zone generator 126 may open a new tab in the web browser of first computer program display area 132 and present interaction zones comprising: 1) image search interaction zone 742 that corresponds to executing an image search based on selected content 702, 2) send to printer interaction zone 644 that corresponds to sending the image of selected content 702 to a printer for printing, 3) add to collections interaction zone 744 that corresponds to executing adding an image file comprising the image of selected content 702 to a collection of the first computer program 112, and 4) share interaction zone 646 that corresponds to sending selected content 702 to text messaging software to add an image file of selected content 702 as an attachment in a text message to be sent via a network.

In step 1108, in response to detecting that the content has been dragged from the display area of the second computer program and dropped into a particular one of the one or more interaction zones, the executable action corresponding to the particular interaction zone may be performed with respect to the content. For example, first computer program 112 may detect that selected content 702, from second computer program 114 has been dragged and dropped in one of the user interaction zones 742, 644, 744, or 646, via user input device 106. In response to detecting that selected content 702 has been dropped into collections interaction zone 744, action handler 128 may execute a save of the image file of selected content 702 in a collection that was configured by the user in first computer program 112.

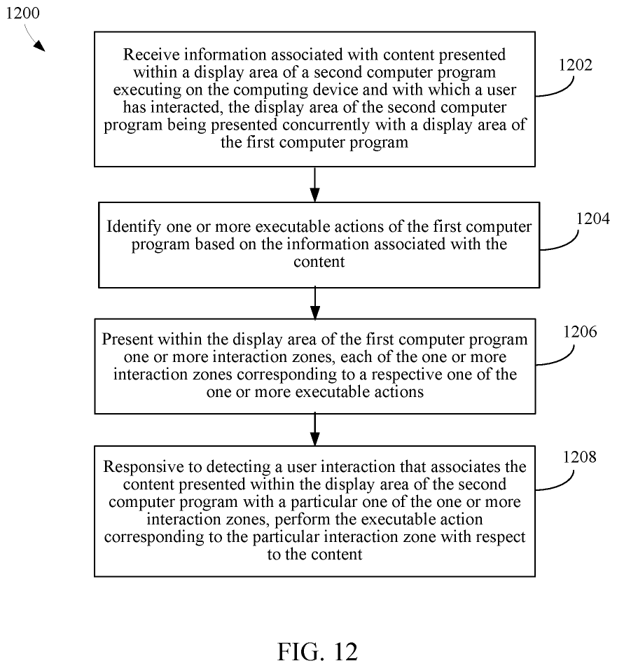

In embodiments, systems 100 and 400 may operate in various ways to perform their functions. FIG. 12 is a flowchart of a method for dynamically and selectively presenting interaction zones for launching an executable action in a display area of a first computer program, according to an example embodiment.

Flowchart 1200 may be performed by computing device 102, display 104, and/or user input device 106. For the purpose of illustration, flowchart 1200 of FIG. 12 is described with reference to FIGS. 1-3 and 8. Flowchart 1200 of FIG. 12 begins with step 1202. In step 1202, information, which is associated with content presented within a display area of a second computer program executing on the computing device and with which a user has interacted, is received. The display area of the second computer program is presented concurrently with a display area of the first computer program. For example, first computer program display area 132 may be displayed concurrently with second computer program display area 130. Selected content 802 (e.g., a URL) may comprise a link to a website. Signal receiver 122 of first computer program 112 may receive the information associated with selected content 802, which may indicate that the content comprises a URL. For example, the associated information may be received in response to a user associating selected content 802 with first computer program display area 132 via user input device 106. Alternatively, or in addition, the information associated with selected content 802 may comprise a content type associated with selected content 802 (e.g., an internet link type of content), formatting information about the selected content, the source of the selected content (e.g., second computer program 114 comprising an email message of an email program), the destination of the selected content (e.g., first computer program 112 comprising a web browser), or a copy of the content (e.g., maysmith.com).

In step 1204, one or more executable actions of the first computer program is identified based on the information associated with the content. For example, mapping engine 124 may determine one or more executable actions that first computer program 112 may be operable to perform with respect to a URL. For example, first computer program 112 may comprise a web browser that presents a webpage of an active search engine, and may be operable to perform an action such as initiating an Internet search based on the URL. First computer program 112 may have a printing feature that may be configured to take an action such as execute sending of the URL to a printer for a printing action. First computer program 112 may have an add to favorites feature that is configured to take an action such as constructing a list of Internet links to favorite websites and/or webpages and adding the URL the favorites list. First computer program 112 may also be configured to send the URL to a printer for a printing action or to a message program to be added as a link in a text message.

In step 1206, one or more interaction zones may be presented within the display area of the first computer program, where each of the one or more interaction zones corresponds to a respective one of the one or more executable actions. For example, zone generator 126 of first computer program 112 may dynamically generate a new tab or overlay 850 comprising user interaction zones for the executable actions that first computer program 112 is capable to perform with respect to the URL of selected content 802. For example, zone generator 126 may open a new tab in the web browser of first computer program display area 132 and present interaction zones in a display area of the new tab. The interaction zones may include: 1) search interaction zone 642 that corresponds to executing an Internet search based on the URL of selected content 802, 2) add to favorites interaction zone 842 that corresponds to executing adding of the URL to a favorites list of the user in first computer program 112, 3) add to collections interaction zone 744 that corresponds to executing adding of the URL to a collection of the user in computer program 112, 4) send to printer interaction zone 644 that corresponds to sending the URL of selected content 802 to a printer for printing, and 5) share interaction zone 646 that corresponds to sending the URL of selected content 802 to messaging software to add the URL as an Internet link in a message to be sent via a network. In some embodiments, first computer program 112 comprising the web browser presenting an active search engine may remain open after the new tab or overlay 850 are opened and/or closed.

In step 1208, in response to detecting a user interaction that associates the content presented within the display area of the second computer program with one of the one or more interaction zones, the executable action corresponding to the particular interaction zone is performed with respect to the content. For example, a user may indicate an association between selected content 802 and one of the user interaction zones 642, 842, 744, 644, or 646 via user input device 106. In response to detecting that the user interaction associates selected content 802 with the add to favorites interaction zone 842, action handler 128 may execute a listing of the URL of selected content 802 in a favorites list configured by the user in first computer program 112.

### III. Example Computer System Implementation

Embodiments described herein may be implemented in hardware, or hardware combined with software and/or firmware. For example, embodiments described herein may be implemented as computer program code/instructions configured to be executed in one or more processors and stored in a computer readable storage medium. Alternatively, embodiments described herein may be implemented as hardware logic/electrical circuitry.

As noted herein, the embodiments described, including but not limited to, systems 100 and 400 along with any components and/or subcomponents thereof, as well any operations and portions of flowcharts/flow diagrams described herein and/or further examples described herein, may be implemented in hardware, or hardware with any combination of software and/or firmware, including being implemented as computer program code configured to be executed in one or more processors and stored in a computer readable storage medium, or being implemented as hardware logic/electrical circuitry, such as being implemented together in a system-on-chip (SoC), a field programmable gate array (FPGA), an application specific integrated circuit (ASIC), a trusted platform module (TPM), and/or the like. A SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

Embodiments described herein may be implemented in one or more computing devices similar to a mobile system and/or a computing device in stationary or mobile computer embodiments, including one or more features of mobile systems and/or computing devices described herein, as well as alternative features. The descriptions of computing devices provided herein are provided for purposes of illustration, and are not intended to be limiting. Embodiments may be implemented in further types of computer systems, as would be known to persons skilled in the relevant art(s).

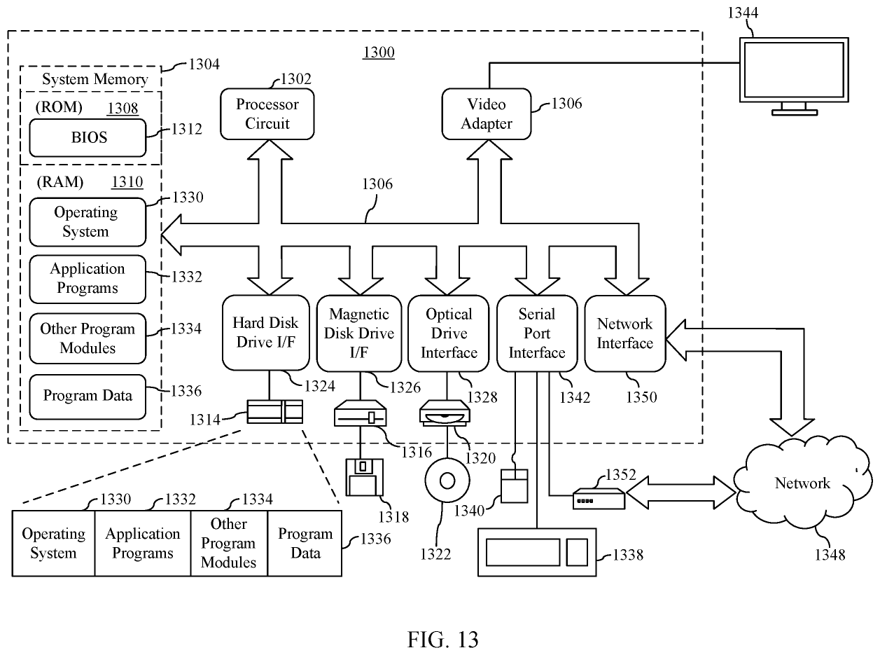

FIG. 13 is a block diagram of an example processor-based computer system 1300 that may be used to implement various embodiments. Computing device 102, display 104, and/or user input device 106 may include any type of computing device, mobile or stationary, such as a desktop computer, a server, a video game console, etc. For example, computing device 102, display 104, and/or user input device 106 may be any type of mobile computing device (e.g., a Microsoft® Surface® device, a personal digital assistant (PDA), a laptop computer, a notebook computer, a tablet computer such as an Apple iPad™, a netbook, etc.), a mobile phone (e.g., a cell phone, a smart phone such as a Microsoft Windows® phone, an Apple iPhone, a phone implementing the Google® Android™ operating system, etc.), a wearable computing device (e.g., a head-mounted device including smart glasses such as Google® Glass™, Oculus Rift® by Oculus VR, LLC, etc.), a stationary computing device such as a desktop computer or PC (personal computer), a gaming console/system (e.g., Microsoft Xbox®, Sony PlayStation®, Nintendo Wii® or Switch®, etc.), etc.

Computing device 102, display 104, and user input device 106, may each be implemented in one or more computing devices containing features similar to those of computing device 1300 in stationary or mobile computer embodiments and/or alternative features. The description of computing device 1300 provided herein is provided for purposes of illustration, and is not intended to be limiting. Embodiments may be implemented in further types of computer systems, as would be known to persons skilled in the relevant art(s).

As shown in FIG. 13, computing device 1300 includes one or more processors, referred to as processor circuit 1302, a system memory 1304, and a bus 1306 that couples various system components including system memory 1304 to processor circuit 1302. Processor circuit 1302 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor circuit 1302 may execute program code stored in a computer readable medium, such as program code of operating system 1330, application programs 1332, other programs 1334, etc. Bus 1306 represents one or more of any of several types of bus structures, including a memory bus or memory controller, a peripheral bus, an accelerated graphics port, and a processor or local bus using any of a variety of bus architectures. System memory 1304 includes read only memory (ROM) 1308 and random-access memory (RAM) 1310. A basic input/output system 1312 (BIOS) is stored in ROM 1308.

Computing device 1300 also has one or more of the following drives: a hard disk drive 1314 for reading from and writing to a hard disk, a magnetic disk drive 1316 for reading from or writing to a removable magnetic disk 1318, and an optical disk drive 1320 for reading from or writing to a removable optical disk 1322 such as a CD ROM, DVD ROM, or other optical media. Hard disk drive 1314, magnetic disk drive 1316, and optical disk drive 1320 are connected to bus 1306 by a hard disk drive interface 1324, a magnetic disk drive interface 1326, and an optical drive interface 1328, respectively. The drives and their associated computer-readable media provide nonvolatile storage of computer-readable instructions, data structures, program modules and other data for the computer. Although a hard disk, a removable magnetic disk and a removable optical disk are described, other types of hardware-based computer-readable storage media can be used to store data, such as flash memory cards, digital video disks, RAMs, ROMs, and other hardware storage media.

A number of program modules may be stored on the hard disk, magnetic disk, optical disk, ROM, or RAM. These programs include operating system 1330, one or more application programs 1332, other programs 1334, and program data 1336. Application programs 1332 or other programs 1334 may include, for example, computer program logic (e.g., computer program code or instructions) for implementing computing device 102, display 104, user input device 106, first computer program 112, second computer program 114, third computer program 302, operating system 110, second computer program display area 130, first computer program display area 132, selected content 502, search interaction zone 642, send to printer interaction zone 644, share interaction zone 646, new tab or overlay 650, selected content 702, image search interaction zone 742, add to collections interaction zone 744, new tab or overlay 750, selected content 802, add to favorites interaction zone 842, new tab or overlay 850, selected content 902, open new message and add to subject line interaction zone 942, reply to message and add as attachment interaction zone 944, forward message and add to body of email interaction zone 946, add to calendar interaction one 948, overlay 950, flowchart 1000, flowchart 1100, flowchart 1200, and/or further embodiments described herein. Program data 1336 may include, text content 402, image content 404, uniform resource locator (URL) content 408, location content 406, temperature and date content 410, selected content 502, selected content 702, selected content 802, selected content 902, and/or further embodiments described herein.

A user may enter commands and information into computing device 1300 through input devices such as keyboard 1338 and pointing device 1340. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor circuit 1302 through a serial port interface 1342 that is coupled to bus 1306, but may be connected by other interfaces, such as a parallel port, game port, or a universal serial bus (USB).

A display screen 1344 is also connected to bus 1306 via an interface, such as a video adapter 1346. Display screen 1344 may be external to, or incorporated in computing device 1300. Display screen 1344 may display information, as well as being a user interface for receiving user commands and/or other information (e.g., by touch, finger gestures, virtual keyboard, etc.). In addition to display screen 1344, computing device 1300 may include other peripheral output devices (not shown) such as speakers and printers.

Computing device 1300 is connected to a network 1348 (e.g., the Internet) through an adaptor or network interface 1350, a modem 1352, or other means for establishing communications over the network. Modem 1352, which may be internal or external, may be connected to bus 1306 via serial port interface 1342, as shown in FIG. 13, or may be connected to bus 1306 using another interface type, including a parallel interface.

As used herein, the terms “computer program medium,” “computer-readable medium,” and “computer-readable storage medium” are used to refer to physical hardware media such as the hard disk associated with hard disk drive 1314, removable magnetic disk 1318, removable optical disk 1322, other physical hardware media such as RAMs, ROMs, flash memory cards, digital video disks, zip disks, MEMs, nanotechnology-based storage devices, and further types of physical/tangible hardware storage media. Such computer-readable storage media are distinguished from and non-overlapping with communication media (do not include communication media). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media that are separate and non-overlapping with embodiments directed to computer-readable storage media.

As noted above, computer programs and modules (including application programs 1332 and other programs 1334) may be stored on the hard disk, magnetic disk, optical disk, ROM, RAM, or other hardware storage medium. Such computer programs may also be received via network interface 1350, serial port interface 1342, or any other interface type. Such computer programs, when executed or loaded by an application, enable computing device 1300 to implement features of embodiments discussed herein. Accordingly, such computer programs represent controllers of computing device 1300.

Embodiments are also directed to computer program products comprising computer code or instructions stored on any computer-readable medium. Such computer program products include hard disk drives, optical disk drives, memory device packages, portable memory sticks, memory cards, and other types of physical storage hardware.

### IV. Additional Examples and Advantages

In an embodiment, a system comprises one or more processors and one or more memory devices. The memory devices store program code of a first computer program to be executed by the one or more processors. The program code comprises a signal receiver that is configured to receive information that is associated with content presented within a display area of a second computer program that executes on the computing device and with which a user has interacted when the display area of the second computer program is presented concurrently with a display area of the first computer program. A mapping engine is configured to identify one or more executable actions of the first computer program based on the information associated with the content. A zone generator is configured to present within the display area of the first computer program one or more interaction zones. Each of the one or more interaction zones corresponds to a respective one of the one or more executable actions. In response to detecting that the content has been dragged from the display area of the second computer program and dropped into a particular one of the one or more interaction zones, an action handler is configured to perform the executable action corresponding to the particular interaction zone with respect to the content.

In an embodiment of the foregoing system, the information associated with the content comprises a copy of the content.

In an embodiment of the foregoing system, the content comprises text, an image, a location, a representation of a file, a uniform resource locator (URL), a video, or audio content.

In an embodiment of the foregoing system, the information associated with the content comprises information associated with the first computer program or the second computer program.

In an embodiment of the foregoing system, the information associated with the content is provided to the first computer program in response to detecting: initiation of dragging of the content within the display area of the second computer program, a spatial direction of dragging of the content towards the display area of the first computer program, dragging of the content across a boundary of the display area of the second computer program, dragging of the content across a boundary of the display area of the first computer program, dragging of the content within a specified distance of the display area of the first computer program, selection of the content in the display area of the second computer program, or hovering the content over the display area of the first computer program.

In an embodiment of the foregoing system, the first computer program is a web browser and the respective one of the one or more executable actions include: a search operation, an add to favorites operation, an add to collections operation, an add to reading list operation, a share operation, a mapping operation, or a print operation.

In an embodiment of the foregoing system, the system comprises a dual screen device. The display area of the first computer program is displayed on a first screen of the dual screen device and the display area of the second computer program is displayed on a second screen of the dual screen device.

In an embodiment of the foregoing system, the second computer program comprises one of a software application or an operating system.

In an embodiment, a method performed by a first computer program executing on a computing device comprises receiving information that is associated with content presented within a display area of a second computer program executing on the computing device and with which a user has interacted. The display area of the second computer program being presented concurrently with a display area of the first computer program. One or more executable actions of the first computer program is identified based on the information associated with the content. One or more interaction zones is presented within the display area of the first computer program. Each of the one or more interaction zones corresponds to a respective one of the one or more executable actions. In response to detecting that the content has been dragged from the display area of the second computer program and dropped into a particular one of the one or more interaction zones, the executable action corresponding to the particular interaction zone is performed with respect to the content.

In an embodiment of the foregoing method, the information associated with the content comprises a copy of the content.

In an embodiment of the foregoing method, the content comprises: text, an image, a location, a representation of a file, a uniform resource locator (URL), a video, or audio content.

In an embodiment of the foregoing method, the information associated with the content comprises information associated with the first computer program or the second computer program.

In an embodiment of the foregoing method, the information associated with the content is provided to the first computer program in response to detecting: initiation of dragging of the content within the display area of the second computer program, a spatial direction of dragging of the content towards the display area of the first computer program, dragging of the content across a boundary of the display area of the first computer program, dragging of the content across a boundary of the display area of the second computer program, dragging of the content within a specified distance of the display area of the first computer program, selection of the content in the display area of the second computer program, or hovering the content over the display area of the first computer program.

In an embodiment of the foregoing method, the first computer program is a web browser and the respective one of the one or more executable actions include: a search operation, an add to favorites operation, an add to collections operation, an add to reading list operation, a share operation, or a print operation.

In an embodiment of the foregoing method, the display area of the first computer program is displayed on a first screen of a dual screen device and the display area of the second computer program is displayed on a second screen of the dual screen device.

In an embodiment of the foregoing method, the second computer program comprises one of a software application or an operating system.

In an embodiment, a method performed by a first computer program executing on a computing device comprises receiving information that is associated with content presented within a display area of a second computer program that executes on the computing device and with which a user has interacted. The display area of the second computer program is presented concurrently with a display area of the first computer program. One or more executable actions of the first computer program is identified based on the information associated with the content. One or more interaction zones is presented within the display area of the first computer program, where each of the one or more interaction zones corresponds to a respective one of the one or more executable actions. In response to detecting a user interaction that associates the content presented within the display area of the second computer program with a particular one of the one or more interaction zones, the executable action corresponding to the particular interaction zone is performed with respect to the content.

In an embodiment of the foregoing method, the user interaction that associates the content presented within the display area of the second computer program with one of the one or more interaction zones comprises input received via a user input device including: a content dragging interaction, a selection interaction, an audible interaction, an eye tracking interaction, or a hand gesture interaction.

In an embodiment of the foregoing method, the information associated with the content comprises a copy of the content.

In an embodiment of the foregoing method, the second computer program comprises one of a software application or an operating system.

### V. Conclusion

While various embodiments of the present application have been described above, it should be understood that they have been presented by way of example only, and not limitation. It will be understood by those skilled in the relevant art(s) that various changes in form and details may be made therein without departing from the spirit and scope of the application as defined in the appended claims. Accordingly, the breadth and scope of the present application should not be limited by any of the above-described exemplary embodiments, but should be defined only in accordance with the following claims and their equivalents.

1. A system comprising:
one or more processors; and
one or more memory devices that store program code of a first computer program to be executed by the one or more processors, the program code comprising:
a signal receiver configured to receive information associated with content presented within a display area of a second computer program executing on a computing device and with which a user has interacted when the display area of the second computer program is presented concurrently with a display area of the first computer program;
a mapping engine configured to identify one or more executable actions the first computer program is operable to perform with respect to the content presented within the display area of the second computer program;
a zone generator configured to:
determine one or more interaction zones based at least in part on the content the user has interacted with in the display area of the second computer program and the identified one or more executable actions the first computer program is operable to perform; and
cause to be dynamically presented within the display area of the first computer program the one or more interaction zones, each of the one or more interaction zones corresponding to a respective one of the identified one or more executable actions; and
an action handler configured to, responsive to detecting that the content has been dragged from the display area of the second computer program and dropped into a particular one of the one or more interaction zones presented within the display area of the first computer program, cause the executable action corresponding to the particular interaction zone to be performed with respect to the dropped content.

2. The system of claim 1, wherein the information associated with the content comprises a copy of the content.

3. The system of claim 1, wherein the content comprises:
text,
an image;
a location;
a representation of a file;
a uniform resource locator (URL);
a video; or
audio content.

4. The system of claim 1, wherein the information associated with the content comprises information associated with:
the first computer program; or
the second computer program.

5. The system of claim 1, wherein the information associated with the content is provided to the first computer program in response to detecting:
initiation of dragging of the content within the display area of the second computer program,
a spatial direction of dragging of the content towards the display area of the first computer program;
dragging of the content across a boundary of the display area of the second computer program;
dragging of the content across a boundary of the display area of the first computer program;
dragging of the content within a specified distance of the display area of the first computer program;
selection of the content in the display area of the second computer program; or
hovering the content over the display area of the first computer program.

6. The system of claim 1, wherein the first computer program is a web browser and the respective one of the one or more executable actions include:
a search operation;
an add to favorites operation;
an add to collections operation;
an add to reading list operation;
a share operation,
a mapping operation, or
a print operation.

7. The system of claim 1, wherein the system comprises a dual screen device and the display area of the first computer program is displayed on a first screen of the dual screen device and the display area of the second computer program is displayed on a second screen of the dual screen device.

8. The system of claim 1, wherein the second computer program comprises one of a software application or an operating system.

9. A method performed by a first computer program executing on a computing device, the method comprising:
receiving information associated with content presented within a display area of a second computer program executing on the computing device and with which a user has interacted, the display area of the second computer program being presented concurrently with a display area of the first computer program;
identifying one or more executable actions of the first computer program is operable to perform with respect to the content presented within the display area of the second computer program;
determining one or more interaction zones based at least in part on the content the user has interacted with in the display area of the second computer program and the identified one or more executable actions the first computer program is operable to perform;
dynamically presenting within the display area of the first computer program the one or more interaction zones, each of the one or more interaction zones corresponding to a respective one of the identified one or more executable actions; and
responsive to detecting that the content has been dragged from the display area of the second computer program and dropped into a particular one of the one or more interaction zones presented within the display area of the first computer program, performing the executable action corresponding to the particular interaction zone with respect to the dropped content.

10. The method of claim 9, wherein the information associated with the content comprises a copy of the content.

11. The method of claim 9, wherein the content comprises:
text,
an image;
a location;
a representation of a file;
a uniform resource locator (URL);
a video; or
audio content.

12. The method of claim 9, wherein the information associated with the content comprises information associated with:
the first computer program; or
the second computer program.

13. The method of claim 9, wherein the information associated with the content is provided to the first computer program in response to detecting:
initiation of dragging of the content within the display area of the second computer program,
a spatial direction of dragging of the content towards the display area of the first computer program;
dragging of the content across a boundary of the display area of the first computer program;
dragging of the content across a boundary of the display area of the second computer program;
dragging of the content within a specified distance of the display area of the first computer program;
selection of the content in the display area of the second computer program; or
hovering the content over the display area of the first computer program.

14. The method of claim 9, wherein the first computer program is a web browser and the respective one of the one or more executable actions include:
a search operation;
an add to favorites operation;
an add to collections operation;
an add to reading list operation;
a share operation, or
a print operation.

15. The method of claim 9, wherein the display area of the first computer program is displayed on a first screen of a dual screen device and the display area of the second computer program is displayed on a second screen of the dual screen device.

16. The method of claim 9, wherein the second computer program comprises one of a software application or an operating system.

17. A method performed by a first computer program executing on a computing device, the method comprising:
receiving information associated with content presented within a display area of a second computer program executing on the computing device and with which a user has interacted, the display area of the second computer program being presented concurrently with a display area of the first computer program;
identifying one or more executable actions of the first computer program is operable to perform with respect to the content presented within the display area of the second computer program;
determining one or more interaction zones based at least in part on the content the user has interacted with in the display area of the second computer program and the identified one or more executable actions the first computer program is operable to perform;
dynamically presenting within the display area of the first computer program the one or more interaction zones, each of the one or more interaction zones corresponding to a respective identified one of the one or more executable actions; and
responsive to detecting a user interaction that associates the content presented within the display area of the second computer program with a particular one of the one or more interaction zones presented within the display area of the first computer program, performing the executable action corresponding to the particular interaction zone with respect to the dropped content.
responsive to detecting that the content has been dragged from the display area of the second computer program and dropped into a particular one of the one or more interaction zones presented within the display area of the first computer program, performing the executable action corresponding to the particular interaction zone with respect to the dropped content.

18. The method of claim 17, wherein the user interaction that associates the content presented within the display area of the second computer program with one of the one or more interaction zones comprises input received via a user input device including:
a content dragging interaction;
a selection interaction;
an audible interaction;
an eye tracking interaction; or
a hand gesture interaction.

19. The method of claim 17, wherein the information associated with the content comprises a copy of the content.

20. The method of claim 17, wherein the second computer program comprises one of a software application or an operating system.
